(19) United States
(12) Patent Application Publication
(10) Pub. No.: US 2006/0125440 A1
(43) Pub. Date: Jun. 15, 2006

(54) Controller for a synchronous motor

(75) Inventors: Benjamin Morris Gordon, Cambridge (GB); Robert Owen Bower, Linton (GB)

Correspondence Address: BARNES & THORNBURG, LLP, P.O. BOX 2786, CHICAGO, IL, 60690-2786, US

(73) Assignee: Cambridge Consultants Limited, Cambridge (GB)

(21) Appl. No.: 10/531,009

(22) PCT Filed: Nov. 6, 2003
(86) PCT No.: PCT/GB03/04762

§ 371 Date: Oct. 3, 2005

(30) Foreign Application Priority Data
Nov. 9, 2002 (GB) 0226317.6

(51) Int. Cl. H02P 6/00

(52) U.S. Cl. 318/723

(57) ABSTRACT

A controller for a synchronous motor, the controller being operable in use to receive from sensor means coupled to a synchronous motor actual angular displacement signals representative of angular displacements from a reference orientation of a rotor of a synchronous motor, to transmit the actual angular displacement signals to a controllable alternating current (ac) supply for the motor, periodically to measure one or more parameters related to the torque of a synchronous motor, and between transmissions of the actual angular displacement signals, to derive from the actual angular displacement signals and measured parameters at least one estimated angular displacement signal representative of an estimated angular displacement from a reference orientation of a rotor of a synchronous motor, to enable the controller to cause to flow between the supply and a synchronous motor a generally sinusoidal current that is synchronised to the angular displacement of the rotor from the reference orientation.

### FIELD OF THE INVENTION

This invention relates to a controller for a synchronous motor, to a synchronous motor drive that includes such a controller, and to a method of controlling a synchronous motor.

### BACKGROUND TO THE INVENTION

Synchronous motor drives, in which angular displacement from a reference orientation of the rotor of a synchronous motor is measured, and each winding of the motor is supplied with an alternating current that is generally synchronised to the angular displacement of the rotor, are well known.

The waveform of the alternating current that can be supplied to each winding of the motor is determined by the resolution of the sensor used to measure the angular displacement of the rotor. For a three-phase motor, for example, the sensor must be capable of measuring the angular displacement of the rotor at least six times during each revolution. If such a sensor is used, the waveform of the current supplied to each winding will be trapezoidal. If instead a high-accuracy resolver is used, capable of measuring the angular displacement of the rotor at least several hundred times during each rotation, the waveform of the current supplied to each winding may be a much closer approximation to sinusoidal.

If the motor is to be supplied with trapezoidal currents, the sensor required is inexpensive, but the trapezoidal currents will cause the motor to produce torque pulsations, leading to relatively noisy operation of the motor.

If the motor is to be supplied with sinusoidal currents, the operation of the motor will be relatively quiet, but the sensor required is expensive, and may even be the most expensive component of the synchronous motor drive.

In an attempt to enable a synchronous motor to be supplied with sinusoidal currents, whilst avoiding the need for a high-resolution sensor, a controller has been developed that receives angular displacement measurements from a low-resolution sensor, and employs a phase-locked loop to generate a pulse train of a frequency determined by the interval between the most recent two angular displacement measurements. The pulse train from the phase-locked loop replaces the angular displacement measurements that would otherwise have been supplied by a high-resolution sensor, and allows the motor to be supplied with substantially sinusoidal currents. Whilst this arrangement results in good synchronisation of the sinusoidal currents to the angular displacement of the rotor under steady-state rotor angular velocity conditions, under transient rotor angular velocity conditions the synchronisation is poor, resulting in noisy operation, and even stalling, of the motor.

A controller has also been proposed that would implement a mathematical model of the motor of sufficient accuracy, would measure the voltage applied to, and current flowing in, each winding of the motor sufficiently frequently, and process the measurements sufficiently quickly, to enable the controller to predict the angular displacement of the rotor, such that no sensor would be required at all. It is likely that the proposed controller would be even more expensive than the high-accuracy resolvers used at present.

### SUMMARY OF THE INVENTION

According to a first aspect of the invention there is provided a controller for a synchronous motor, the controller being operable in use to receive from sensor means coupled to a synchronous motor actual angular displacement signals representative of angular displacements from a reference orientation of a rotor of a synchronous motor, to transmit the actual angular displacement signals to a controllable alternating current (ac) supply for the motor, periodically to measure one or more parameters related to the torque of a synchronous motor, and between transmissions of the actual angular displacement signals, to derive from the actual angular displacement signals and measured parameters at least one estimated angular displacement signal representative of an estimated angular displacement from a reference orientation of a rotor of a synchronous motor, to enable the controller to cause to flow between the supply and a synchronous motor a generally sinusoidal current that is synchronised to the angular displacement of the rotor from the reference orientation.

The invention therefore provides a controller for use with a synchronous motor that enables each winding of a motor to be supplied with a generally sinusoidal current, and which requires only a relatively low-resolution shaft position sensor, but which provides improved synchronisation of the sinusoidal current to the angular displacement of the rotor under transient rotor angular velocity conditions.

The one or more parameters related to a torque of a synchronous motor may advantageously include a voltage across, or a current flowing in, a winding of the motor. Alternatively or in addition, the one or more parameters may advantageously include a characteristic of a load coupled to the motor, for example, a pressure developed by a pump driven by the motor.

In a preferred embodiment the controller is operable to store a mathematical model of a synchronous motor, and to derive the at least one estimated angular displacement signal by inserting the measured parameters into the mathematical model.

In the preferred embodiment the controller is operable periodically to receive a first signal proportional to a voltage applied across a winding of a synchronous motor, and a second signal proportional to a current flowing between the supply and the motor, said first and second signals constituting said parameters.

Preferably the controller is operable, upon receiving an actual angular displacement signal, to subtract an estimated angular displacement signal from the actual angular displacement signal, to generate an angular displacement error signal and to adjust the mathematical model so as to reduce the magnitudes of subsequent angular displacement error signals.

In the preferred embodiment the controller is operable periodically to derive from the actual angular displacement signals and measured parameters an estimated angular velocity signal representative of an estimated angular velocity of the rotor, and to transmit the estimated angular velocity signal to an angular velocity governor.

According to a second aspect of the invention there is provided a synchronous motor drive comprising a controller in accordance with the first aspect of the invention, a synchronous motor, a controllable alternating current (ac) supply, and sensor means coupled to a rotor of the motor and operable periodically to transmit to the controller an actual angular displacement signal representative of an angular displacement from a reference orientation of the rotor, the controllable ac supply being operable to receive actual and estimated angular displacement signals from the controller and, in response to the angular displacement signals, to supply to each winding of the motor a generally sinusoidal current that is synchronised to the angular displacement of the rotor from the reference orientation.

Preferably the controllable ac supply is a PWM inverter.

Preferably the PWM inverter is a three-phase inverter and the synchronous motor is a three-phase synchronous motor.

Preferably the synchronous motor is a permanent-magnet synchronous motor.

The sensor means may advantageously comprise a plurality of Hall effect sensors.

Preferably the sensor means comprises three Hall effect sensors, which are so arranged relative to the motor as to generate an actual angular displacement signal for each 60° of angular displacement of the rotor from the reference orientation.

Preferably the controller is operable to measure the one or more parameters related to the speed of the motor and to transmit an actual or estimated angular displacement signal to the controllable ac supply at intervals that are much less than a response time of the motor.

It is to be appreciated that the response time of the motor varies with, amongst other factors, inertia of a load coupled to the rotor, and temperature of the motor windings. Nevertheless, the synchronous motor drive will operate satisfactorily if the controller is operable to transmit at least several hundred angular displacement signals to the controllable ac supply during each revolution of the rotor.

Where the controller is operable to transmit estimated angular velocity signals to a governor, the synchronous motor drive may advantageously further comprise a governor operable to receive estimated angular velocity signals from the controller, to subtract the estimated angular velocity signals from a demanded angular velocity signal representative of a demanded angular velocity of the rotor set by a user of the drive, so as to generate an angular velocity error signal, and to cause the controllable ac supply to increase or decrease the amplitude of the generally sinusoidal current so as to reduce the magnitudes of the angular velocity error signals.

According to a third aspect of the invention there is provided a method of controlling a synchronous motor, comprising the steps of receiving from sensor means coupled to a synchronous motor an actual angular displacement signal representative of an angular displacement from a reference orientation of a rotor of the motor, transmitting the actual angular displacement signal to a controllable alternating current (ac) supply, measuring one or more parameters related to an angular acceleration of the rotor, deriving, using a mathematical model of the motor, from the actual displacement signal and the one or more parameters an estimated angular displacement signal representative of an estimated angular displacement of the rotor, transmitting the estimated angular displacement signal to the controllable ac supply, and thereby causing to flow between the controllable ac supply and the motor a generally sinusoidal current that is synchronised to the angular displacement of the rotor.

Preferably the method further comprises the step of measuring the one or more parameters related to an angular acceleration of the rotor, deriving, using the mathematical model, from the estimated angular displacement and the one or more parameters a further estimated angular displacement signal representative of an estimated angular displacement of the rotor, and transmitting the further estimated angular displacement signal to the controllable ac supply.

Preferably the method further comprises the step, upon receipt of an actual angular displacement signal, of comparing the actual angular displacement signal with a further estimated angular displacement signal to generate an angular displacement error signal, and adjusting the mathematical model so as to reduce the magnitude of subsequent angular displacement signals.

### BRIEF DESCRIPTION OF THE DRAWINGS

The invention will now be described by way of illustrative example and with reference to the accompanying drawings, in which:

FIG. 1 is a block diagram of a synchronous motor drive in accordance with the second aspect of the invention; and

FIG. 2 is a block diagram of a motor modeller forming part of a controller in accordance with the first aspect of the invention.

### DETAILED DESCRIPTION OF AN EMBODIMENT

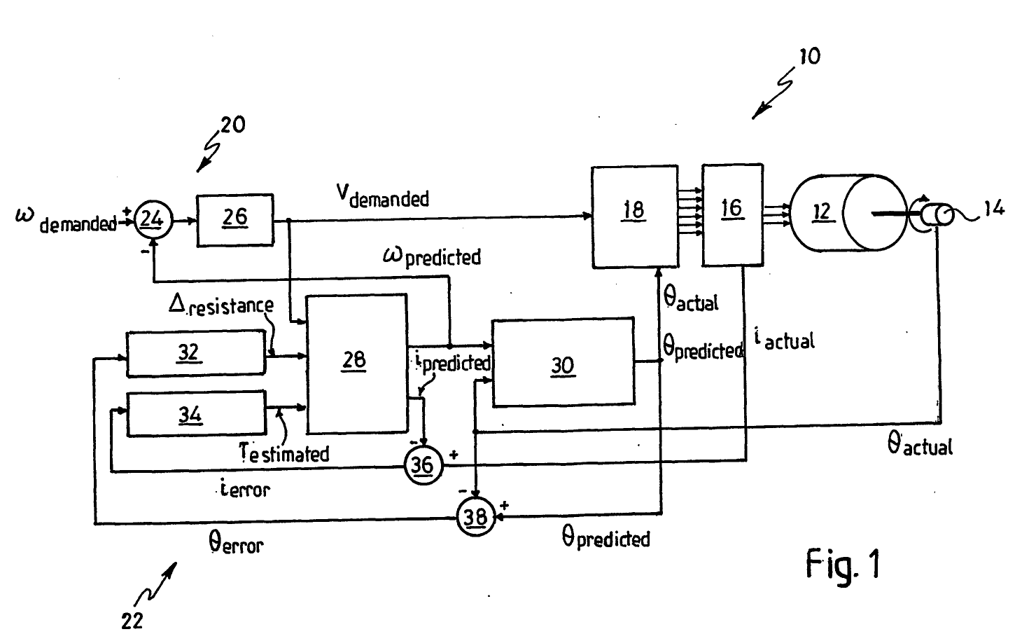

The synchronous motor drive 10 of FIG. 1 comprises a three-phase permanent-magnet synchronous motor 12, a rotor angular displacement sensor 14, a three-phase bridge 16 controlled by a sinusoidal pulse-width modulated (PWM) signal generator 18, a rotor angular velocity governor indicated generally by reference numeral 20 and a discrete-time controller indicated generally by reference numeral 22.

The rotor angular displacement sensor 14 is attached to a shaft of the motor 12 and is made up of three Hall effect sensors (not shown), so arranged that an actual angular displacement signal, representative of an angular displacement of a rotor of the motor from a reference orientation, is generated for each 60° of angular displacement of the rotor from the reference orientation. The frequency at which actual angular displacement signals are generated by the rotor angular displacement sensor is therefore determined by the angular velocity of the rotor.

The three-phase bridge 16 is connected between a direct current power supply (not shown) and the motor 12 and causes generally sinusoidal currents to flow between the supply and each winding of the motor.

The PWM signal generator 18 is connected to the bridge 16, the governor 20 and the controller 22. It receives angular displacement signals from the controller and demanded voltage signals from the governor, and transmits to the bridge 16 sinusoidal PWM signals of fundamental frequencies determined by the angular displacement signals and duty ratios determined by the demanded voltage signals.

The governor 20 receives demanded angular velocity signals from a user of the drive and predicted angular velocity signals from the controller 22, and transmits to the PWM signal generator 18 demanded voltage signals so as to make the predicted angular velocity signals equal to the demanded angular velocity signals.

The controller 22 samples the outputs of the rotor angular displacement sensor 14, bridge 16 and governor 20 with a sampling frequency of 1 kHz and generates and transmits control signals to the PWM signal generator 18 and governor 20 at the sampling frequency. The sampling frequency of 1 kHz is selected such that the PWM signal generator 18 receives at least one hundred angular displacement signals during each revolution of the rotor for angular velocities of the rotor up to 600 revolutions per minute.

The output of the rotor angular displacement sensor 14 is sampled by the controller 22 to generate actual angular displacement samples, θ_{actual}. The actual angular displacement signals generated by the sensor are of relatively short duration and will in general each occupy only one actual angular displacement sample. If the rotor is rotating at 600 revolutions per minute, say, the rotor angular displacement sensor will generate actual angular displacement signals at 60 Hz. Since the output of the rotor angular displacement sensor is sampled at 1 kHz, only a minority of the actual angular displacement samples will be samples of actual angular displacement signals, and the remainder of the actual angular displacement samples will be zero.

The controller also samples the currents flowing between the supply and each winding of the motor to generate actual motor current samples, i_{actual}, and samples the demanded voltage signal transmitted to the PWM signal generator 18 by the governor 20 to generate demanded voltage samples, v_{demanded}. Every millisecond the controller generates a predicted angular displacement signal, θ_{predicted}, and transmits to the PWM signal generator 18 either an actual angular displacement sample, if the most recent angular displacement sample is non-zero, or the predicted angular displacement signal, if the angular displacement sample is zero. At the same time, the controller also generates a predicted angular velocity signal, ω_{predicted}, and transmits the predicted angular velocity signal to the governor 20.

The governor 20 is made up of an angular velocity signal comparator 24 and a demanded voltage signal generator 26. The angular velocity signal comparator receives demanded angular velocity signals, ω_{demanded}, representative of angular velocities of the rotor demanded by a user of the drive, and predicted angular velocity signals from the controller 22, subtracts the predicted angular velocity signals from the demanded angular velocity signals to generate angular velocity error signals, vₑᵣᵣₒᵣ, and transmits the angular velocity error signals to the demanded voltage signal generator 26. The demanded voltage signal generator generates demanded voltage signals so as to reduce the magnitude of the angular velocity error signals.

The controller 22 is made up of a motor modeller 28, an angular displacement predictor 30, a resistance trimmer 32, a proportional-integral (PI) controller 34 and current signal and angular displacement signal comparators 36 and 38 respectively.

Each millisecond an actual angular displacement sample is received by the angular displacement predictor 30 and angular displacement signal comparator 38. At the same time the angular displacement signal comparator receives a predicted angular displacement signal from the angular displacement predictor. If the actual angular displacement sample is zero, it is disregarded by both the angular displacement predictor and the angular displacement signal comparator. If, on the other hand, the actual angular displacement sample corresponds to an actual angular displacement signal, it is transmitted by the angular displacement predictor to the PWM signal generator, and subtracted by the angular displacement signal comparator from the most recently received predicted angular displacement signal to generate an angular displacement error signal, θₑᵣᵣₒᵣ, which is transmitted by the angular displacement signal comparator to the resistance trimmer 32. The resistance trimmer 32 therefore receives angular displacement error signals at approximately the same frequency as the rotor angular displacement sensor generates actual angular displacement signals.

In response to each angular displacement error signal the resistance trimmer 32 generates a resistance trim signal, Δ_{resistance}, representative of an adjustment to a nominal value of the resistance of the windings of the motor, so as to reduce the magnitude of subsequent angular displacement error signals. The resistance trimmer 32 is designed primarily to enable the motor modeller 28 to compensate for inaccuracies of the model due to changes in the resistance of the windings of the motor with temperature. However, to a limited extent, the resistance trimmer is also able to compensate for other inaccuracies of the model, for example changes in the inertia of the rotor with angular velocity.

Each millisecond an actual motor current sample is received by the current signal comparator 36, together with a predicted motor current signal, i_{predicted}, generated by the motor modeller 28. The current signal comparator subtracts the predicted motor current signal from the actual motor current sample to generate a motor current error signal, iₑᵣᵣₒᵣ, which it transmits to the PI controller 34.

The PI controller generates estimated load torque signals, T_{estimated}, and transmits the estimated load torque signals to the motor modeller 28. The motor modeller generates the predicted motor current signals from the estimated torque signals, which are generated by the PI controller so as to reduce the magnitudes of subsequent motor current error signals.

The motor modeller 28 samples the demanded voltage signals generated by the demanded voltage signal generator 26 every millisecond and generates from the demanded voltage sample and estimated load torque signal a predicted rotor angular velocity signal, ω_{predicted}, which it transmits to the rotor angular displacement predictor 30 and angular velocity signal comparator 24.

The angular displacement predictor 30 stores the most recent actual angular displacement signal from the rotor angular displacement sensor, and generates a predicted angular displacement signal by integrating the predicted rotor angular velocity signal and adding the integrated signal to the stored actual angular displacement signal. Subsequent estimated angular displacement signals are generated by integrating subsequent predicted angular velocity signals from the motor modeller and adding the integrated signal to the previous estimated angular displacement signal.

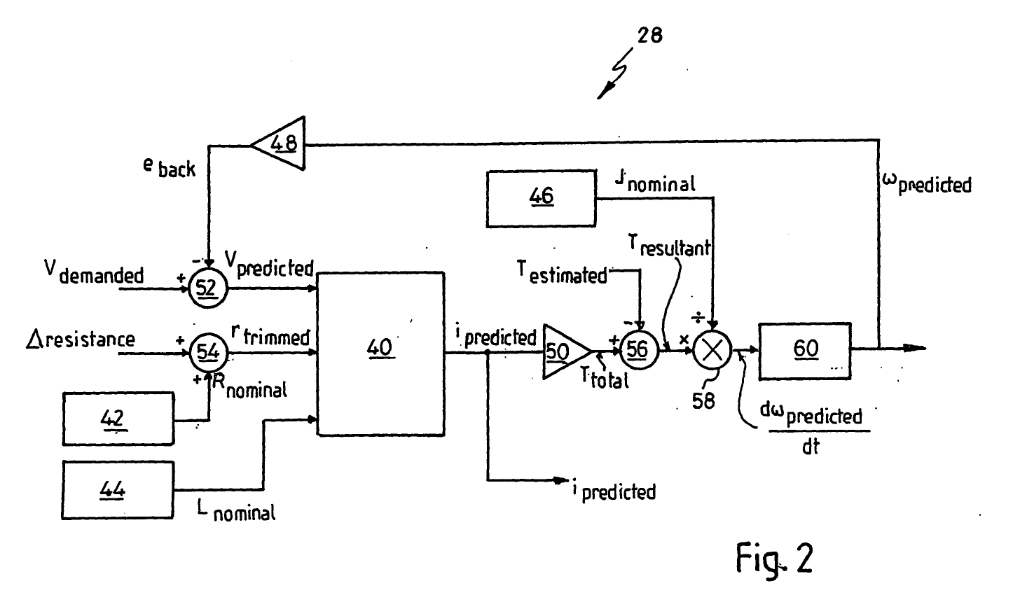

Turning next to FIG. 2, which shows the motor modeller 28 in greater detail, the motor modeller is made up of a signal processor 40, a resistance memory 42 containing a nominal value for the resistance of the motor windings, an inductance memory 44 containing a nominal value for the inductance of the motor windings, an inertia memory 46 containing a nominal value for the inertia of the rotor and any load attached thereto, an angular velocity signal amplifier 48, a current signal amplifier 50, a voltage signal comparator 52, a resistance signal adder 54, a load torque signal comparator 56, an attenuator 58 and an integrator 60.

The voltage signal comparator 52 receives a demanded voltage sample, v_{demanded}, and a predicted back emf signal, e_{back}, from the angular velocity signal amplifier 48, subtracts the predicted back emf signal from the demanded voltage sample to generate a predicted winding voltage, v_{predicted}, representative of a predicted voltage developed across each winding of the motor, and transmits the predicted winding voltage to the signal processor 40.

Whenever the resistance signal adder 54 receives a resistance trim signal, Δ_{resistance}, from the resistance trimmer (not shown in FIG. 2), it adds the resistance trim signal to the nominal value, Rₙₒₘᵢₙₐₗ, of the motor winding resistance stored in the resistance memory 42 and transmits the resulting trimmed resistance value, r_{trimmed}, to the signal processor 40, which stores the trimmed resistance value. The inductance memory 44 transmits the nominal motor winding inductance value, Lₙₒₘᵢₙₐₗ, to the signal processor 40, which stores the inductance value.

The signal processor generates a predicted motor current, i_{predicted}, from the predicted winding voltage, v_{predicted}, trimmed resistance value, r_{trimmed}, nominal inductance value, Lₙₒₘᵢₙₐₗ, and previous predicted motor currents, from which a rate of change of motor current is derived. The predicted motor current is transmitted to the current signal comparator (not shown in FIG. 2), and to the current signal amplifier 50.

The current signal amplifier has a gain corresponding to the torque constant of the motor, and converts the predicted motor current signal into an estimated total torque signal, Tₜₒₜₐₗ, representative of the total torque produced by the motor as a result of the predicted motor current. The torque signal comparator receives the estimated total torque signal and an estimated torque signal, T_{estimated}, from the PI controller (not shown in FIG. 2), subtracts the estimated load torque from the total torque signal to generate a resultant torque signal, Tᵣₑₛᵤₗₜₐₙₜ, which it transmits to the attenuator 58.

The attenuator has an attenuation determined by a nominal inertia value, Jₙₒₘᵢₙₐₗ, stored in the inertia memory 46, and divides the resultant torque signal by the nominal inertia value to generate a predicted rotor angular acceleration signal, dω_{predicted}/dt, which it transmits to the integrator 60. The integrator 60 integrates the predicted rotor angular acceleration signal to generate a predicted rotor angular velocity signal, ω_{predicted}, which it transmits to the rotor angular displacement predictor (not shown in FIG. 2) and to the angular velocity signal amplifier 48.

The angular velocity signal amplifier has a gain corresponding to the emf constant of the motor and converts the predicted angular velocity signal into a predicted back emf signal representative of the predicted back emf, e_{back}, of the motor, and transmits the predicted back emf signal to the voltage signal comparator 52.

It will be apparent that the above description relates only to one embodiment of the invention, and that the invention encompasses other embodiments as defined by the statements of the invention.

1. A controller for a synchronous motor, the controller being operable in use to receive from sensor means coupled to a synchronous motor actual angular displacement signals representative of angular displacements from a reference orientation of a rotor of a synchronous motor, to transmit the actual angular displacement signals to a controllable alternating current (ac) supply for the motor, periodically to measure one or more parameters related to the torque of a synchronous motor, and between transmissions of the actual angular displacement signals, to derive from the actual angular displacement signals and measured parameters at least one estimated angular displacement signal representative of an estimated angular displacement from a reference orientation of a rotor of a synchronous motor, to enable the controller to cause to flow between the supply and a synchronous motor a generally sinusoidal current that is synchronised to the angular displacement of the rotor from the reference orientation.

2. A controller according to claim 1, which is operable periodically to measure one or more parameters related to a torque of a synchronous motor, which parameters include a voltage across, or a current flowing in, a winding of the motor.

3. A controller according to claim 1, which is operable periodically to measure one or more parameters related to a torque of a synchronous motor, which parameters include a characteristic of a load coupled to the motor.

4. A controller according to claim 1, which is operable to store a mathematical model of a synchronous motor, and to derive the at least one estimated angular displacement signal by inserting the measured parameters into the mathematical model.

5. A controller according to claim 1, which is operable periodically to receive a first signal proportional to a voltage applied across a winding of a synchronous motor, and a second signal proportional to a current flowing between the supply and the motor, said first and second signals constituting said parameters.

6. A controller according to claim 1, which is operable, upon receiving an actual angular displacement signal, to subtract an estimated angular displacement signal from the actual angular displacement signal, to generate an angular displacement error signal and to adjust the mathematical model so as to reduce the magnitudes of subsequent angular displacement error signals.

7. A controller according to claim 1, which is operable periodically to derive from the actual angular displacement signals and measured parameters an estimated angular velocity signal representative of an estimated angular velocity of the rotor, and to transmit the estimated angular velocity signal to an angular velocity governor.

8. A synchronous motor drive comprising a controller in accordance with claim 1, a synchronous motor, a controllable alternating current (ac) supply, and sensor means coupled to a rotor of the motor and operable periodically to transmit to the controller an actual angular displacement signal representative of an angular displacement from a reference orientation of the rotor, the controllable ac supply being operable to receive actual and estimated angular displacement signals from the controller and, in response to the angular displacement signals, to supply to each winding of the motor a generally sinusoidal current that is synchronised to the angular displacement of the rotor from the reference orientation.

9. A synchronous motor drive according to claim 8, wherein the controllable ac supply is a PWM inverter.

10. A synchronous motor drive according to claim 9, wherein the PWM inverter is a three-phase inverter and the synchronous motor is a three-phase synchronous motor.

11. A synchronous motor drive according to claim 8, wherein the synchronous motor is a permanent-magnet synchronous motor.

12. A synchronous motor drive according to claim 8, wherein the sensor means comprises a plurality of Hall effect sensors.

13. A synchronous motor drive according to claim 12, wherein the sensor means comprises three Hall effect sensors, which are so arranged relative to the motor as to generate an actual angular displacement signal for each 60° of angular displacement of the rotor from the reference orientation.

14. A synchronous motor drive according to claim 8, wherein the controller is operable to measure the one or more parameters related to the speed of the motor and to transmit an actual or estimated angular displacement signal to the controllable ac supply at intervals that are much less than a response time of the motor.

15. A synchronous motor drive according to claim 8 when dependent from claim 7, which further comprises a governor operable to receive estimated angular velocity signals from the controller, to subtract the estimated angular velocity signals from a demanded angular velocity signal representative of a demanded angular velocity of the rotor set by a user of the drive, so as to generate an angular velocity error signal, and to cause the controllable ac supply to increase or decrease the amplitude of the generally sinusoidal current so as to reduce the magnitudes of the angular velocity error signals.

16. A method of controlling a synchronous motor, comprising the steps of receiving from sensor means coupled to a synchronous motor an actual angular displacement signal representative of an angular displacement from a reference orientation of a rotor of the motor, transmitting the actual angular displacement signal to a controllable alternating current (ac) supply, measuring one or more parameters related to an angular acceleration of the rotor, deriving, using a mathematical model of the motor, from the actual displacement signal and the one or more parameters an estimated angular displacement signal representative of an estimated angular displacement of the rotor, transmitting the estimated angular displacement signal to the controllable ac supply, and thereby causing to flow between the controllable ac supply and the motor a generally sinusoidal current that is synchronised to the angular displacement of the rotor.

17. A method according to claim 16, which further comprises the step of measuring the one or more parameters related to an angular acceleration of the rotor, deriving, using the mathematical model, from the estimated angular displacement and the one or more parameters a further estimated angular displacement signal representative of an estimated angular displacement of the rotor, and transmitting the further estimated angular displacement signal to the controllable ac supply.

18. A method according to claim 17, which further comprises the step, upon receipt of an actual angular displacement signal, of comparing the actual angular displacement signal with a further estimated angular displacement signal to generate an angular displacement error signal, and adjusting the mathematical model so as to reduce the magnitude of subsequent angular displacement signals.
